(19) United States
(12) Patent Application Publication
(10) Pub. No.: US 2011/0081576 A1
(43) Pub. Date: Apr. 7, 2011

(54) Negative electrode for a lithium battery, method of manufacturing the same, and lithium battery including the negative electrode

(76) Inventors: Gu-Hyun Chung, Suwon-si (KR); Jae-Myung Kim, Suwon-si (KR); Kyu-Nam Joo, Suwon-si (KR); So-Ra Lee, Suwon-si (KR); Jong-Hee Lee, Suwon-si (KR); Young-Su Kim, Suwon-si (KR); Deok-Hyun Kim, Suwon-si (KR)

(21) Appl. No.: 12/805,647

(22) Filed: Aug. 11, 2010

(30) Foreign Application Priority Data
Oct. 1, 2009 (KR) 10-2009-0094048

(51) Int. Cl. H01M 4/58; H01M 4/82

(52) U.S. Cl. 429/218.1; 29/623.1

(57) ABSTRACT

A negative electrode for a lithium battery, a method of manufacturing the same, and a lithium battery including the negative electrode, the negative electrode including a collector; and an active material layer, wherein the active material layer includes an indium tin oxide material capable of intercalation and deintercalation of lithium ions.

### BACKGROUND

1. Field

Embodiments relate to a negative electrode for a lithium battery, a method of manufacturing the same, and a lithium battery including the negative electrode.

2. Description of the Related Art

Lithium secondary batteries have recently received attention as a power source for small and portable electronic devices. Since lithium secondary batteries include an organic electrolyte, they have a discharge voltage that is at least twice as high as that of a conventional battery including an alkali aqueous solution, and thus have high energy density.

A positive electrode active material for lithium secondary batteries may include, e.g., LiCoO₂, LiMn₂O₄, and LiNi₁₋ₓCoₓO₂ where 0≦x≦1. In other words, the positive electrode active material may include, e.g., an oxide that contains lithium and a transition metal and has a structure enabling intercalation of lithium ions.

Although carbonaceous materials, e.g., artificial or natural graphite and hard carbon, having a structure enabling intercalation and deintercalation of lithium ions may be used as a negative electrode active material for lithium secondary batteries, demands for stability and high capacity have recently led to research into non-carbonaceous materials, e.g., Si, since they may have a capacity that is 10 times greater than that of graphite.

### SUMMARY

Embodiments are directed to a negative electrode for a lithium battery, a method of manufacturing the same, and a lithium battery including the negative electrode, which represents advances the related art.

It is a feature of an embodiment to provide a negative electrode for a lithium battery, having improved capacity characteristics and cycle lifetime characteristics.

At least one of the above and other features and advantages may be realized by providing a negative electrode for a lithium battery, the negative electrode including a collector; and an active material layer, wherein the active material layer includes an indium tin oxide material capable of intercalation and deintercalation of lithium ions.

The active material layer may have a matrix structure including a plurality of pores.

The pores may have a minimum diameter of about 200 nm and a maximum diameter of about 500 nm.

One or more pores among the pores may be spherical.

A standard deviation of diameters of the pores may be about 0 nm to about 10 nm.

All of the pores may be spherical, and the pores may be three-dimensionally arranged such that each of interior angles of an imaginary triangle formed by connecting centers of three adjacent pores among the pores is about 60±10°, or one of the interior angles is about 90±10°.

All of the pores may be spherical, and the pores may be three-dimensionally arranged such that absolute values of differences in lengths of sides of an imaginary triangle formed by connecting centers of three adjacent pores among the pores are less than about 10 nm.

All of the pores may be spherical, and the pores are three-dimensionally arranged such that an imaginary triangle formed by connecting centers of three adjacent pores among the pores is an equilateral triangle or a right triangle.

All of the pores may be spherical, and the pores may be three-dimensionally arranged such that 0 nm≦L₁-D₁-D₂≦100 nm where L₁ is a length of a side of an imaginary triangle formed by connecting centers of three adjacent pores among the pores and D₁ and D₂ are diameters of pores that are contained in the selected side.

All of the pores may be spherical, and the pores may be three-dimensionally arranged such that 0 nm≦L₄-D₄-D₅≦100 nm where L₄ is a length of one of the sides other than a longest side of an imaginary triangle formed by connecting centers of three adjacent pores among the pores, and D₄ and D₅ are diameters of pores that are contained in the selected side.

One or more pores among the pores may include a residue coal.

The active material layer may have a porosity of about 20% to about 80%.

The active material layer may have a specific surface area of about 100 m²/g to about 700 m²/g.

At least one of the above and other features and advantages may also be realized by providing a lithium battery including the negative electrode of an embodiment, a positive electrode, and an electrolyte.

At least one of the above and other features and advantages may also be realized by providing a method of manufacturing a negative electrode for a lithium battery, the method including forming a first layer on a collector such that the first layer includes a plurality of templates for forming pores; forming a second layer by providing a mixture including a precursor of indium tin oxide to the first layer to introduce the mixture among the templates; and forming an active material layer on the collector by heat-treating the collector having the first layer and the second layer thereon to remove the templates and to convert the precursor of the indium tin oxide into an indium tin oxide matrix, such that the active material layer having an indium tin oxide matrix structure includes a plurality of pores.

The templates may have a minimum diameter of about 200 nm and a maximum diameter of about 500 nm.

The templates may include at least one of polystyrene-based beads, polycarbonate-based beads, polyacrylate-based beads, and polymethacrylate-based beads.

All of the templates may be spherical; and the templates may be arranged such that an imaginary triangle formed by connecting centers of three adjacent templates among the templates is an equilateral triangle or a right triangle.

The heat-treatment may be performed at a temperature of about 300° C. to about 400° C.

The pores may replace the templates as the templates are removed.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic cross-sectional view of a negative electrode according to an embodiment;

FIG. 2 illustrates a sectional view taken along a line I-I′ of the negative electrode of FIG. 1;

FIG. 3 illustrates an enlarged schematic view of a portion of an active material layer illustrated in FIG. 2 according to an embodiment;

FIG. 4 illustrates an enlarged schematic view of a portion of the active material layer illustrated in FIG. 2 according to another embodiment;

FIGS. 5A through 5C illustrate stages in a method of manufacturing a negative electrode according to an embodiment;

FIG. 6 illustrates an exploded perspective view of a lithium battery according to an embodiment;

FIGS. 7 and 8A illustrate scanning electron microscope (SEM) images of a cross-section of an active material layer manufactured according to Example 1;

FIG. 8B illustrates an imaginary triangle formed by connecting centers of three adjacent pores among pores illustrated in FIG. 8A;

FIG. 9A illustrates a SEM image of a surface of an active material layer manufactured according to Comparative Example 1,

FIG. 9B illustrates a SEM image of a cross-section of the active material layer manufactured according to Comparative Example 1; and

FIG. 10 illustrates a graph showing charge and discharge characteristics of test cells including negative electrodes manufactured according to Example 1 and Comparative Example 1.

### DETAILED DESCRIPTION

Korean Patent Application No. 10-2009-0094048, filed on Oct. 1, 2009, in the Korean Intellectual Property Office, and entitled: “Negative Electrode for Lithium Battery, Method of Manufacturing the Same, and Lithium Battery Including Negative Electrode,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

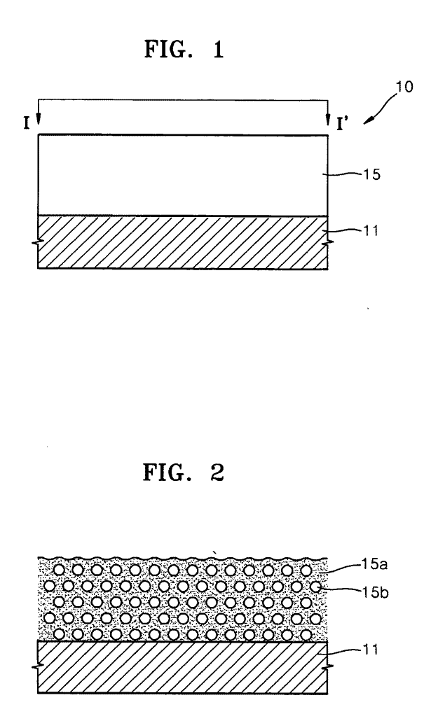

FIG. 1 illustrates a schematic cross-sectional view of a negative electrode 10 according to an embodiment. The negative electrode 10 may include a collector 11 and an active material layer 15. One surface of the active material layer 15 may contact one surface of the collector 11.

The collector 11 may be, e.g., a copper foil, a nickel foil, a stainless steel foil, a titanium foil, a nickel foam, a copper foam, or a polymer support coated with a conductive metal, but is not limited thereto. In an implementation, the collector 11 may include a mixture of these materials and/or a stack of supports made of these materials.

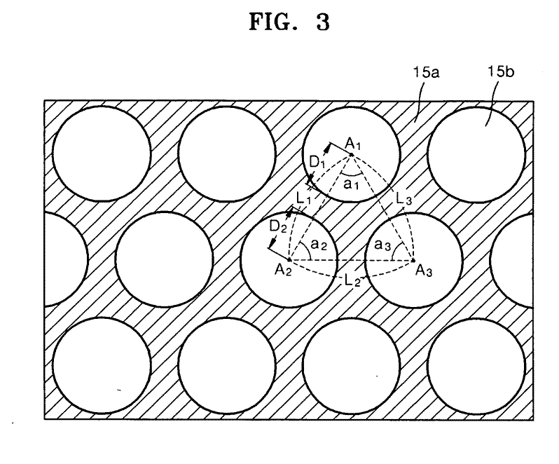

FIG. 2 illustrates a sectional view taken along a line I-I′ of the negative electrode 10 of FIG. 1. The active material layer 15 may include a material enabling, i.e., facilitating or being capable of, intercalation and deintercalation of lithium ions. In an implementation, the material enabling intercalation and deintercalation of lithium ions may be, e.g., an indium tin oxide (ITO). An atomic ratio of indium to tin in the ITO may be about 10:1 to about 90:1. The atomic ratio may be appropriately selected in consideration of desired characteristics of a target battery. The atomic ratio of indium to tin may be controlled by, e.g., adjusting amounts of a precursor of indium and a precursor of tin, but other methods may also be used to control the atomic ratio of indium to tin.

The active material layer 15 may include a matrix 15a including the ITO and a plurality of pores 15b in the matrix 15a.

One or more pores 15b may be spherical, but the shape is not limited thereto. Since beads that may be used as templates for forming the pores 15b may be spherical, the one or more pores may be spherical as well.

According to the present embodiment, the one or more pores among the pores 15b may be spherical. In the present specification, the term “spherical” also refer to not being completely round. That is, the term “spherical” may be also regarded as any shape that is substantially round, e.g., the shape of a soccer ball.

Due to the pores 15b in the active material layer 15, more lithium ions may be contained therein. Thus, the negative electrode 10 may have a higher capacity.

A minimum diameter of the pores 15b may be about 200 nm and a maximum diameter of the pores 15b may be about 500 nm. In an implementation, diameters of the pores 15b may be about 220 nm to about 480 nm, but the diameters are not limited thereto.

A standard deviation of the diameters of the pores 15b may be, e.g., about 0 nm to about 10 nm. The standard deviation of the diameters of the pores 15b may be controlled by adjusting, e.g., a standard deviation of diameters of templates that are used to form the pores 15b. In an implementation, diameters of the pores 15b may be substantially identical to each other (that is, the standard deviation of the diameters of the pores 15b may be 0).

FIG. 3 illustrates an enlarged schematic view of a portion of the active material layer 15 of FIG. 2 according to an embodiment.

The pores 15b illustrated in FIG. 3 may all be spherical.

According to the present embodiment, the pores 15b included in the active material layer 15 of the negative electrode 10 may be, as illustrated in FIG. 3, three-dimensionally arranged in such a way that each of interior angles a1, a2 and a3 of an imaginary triangle formed by connecting centers A1, A2 and A3 of three adjacent pores among the pores 15b may be about 60±10°, e.g., 60±5°.

For example, the pores 15b may be arranged in such a way that each of the interior angles a1, a2, and a3 of the imaginary triangle may be 60±5°, 60±4°, 60±3°, 60±2°, 60±1°, or 60.

The pores 15b may be, as illustrated in FIG. 3, three-dimensionally arranged in such a way that differences in lengths L₁, L₂, and L₃ of sides of the imaginary triangle formed by connecting the centers A₁, A₂, and A₃ of three adjacent pores among the pores 15b, i.e., the absolute value of L₁-L₂, the absolute value of L₂-L₃, and the absolute value of L₃-L₁, may be less than about 10 nm.

For example, the pores 15b may be arranged in such a way that the difference in the lengths L₁, L₂, and L₃ (the absolute value of L₁-L₂, the absolute value of L₂-L₃, and the absolute value of L₃-L₁) may each be about 10 nm, 9 nm, 8 nm, 7 nm, 6 nm, 5 nm, 4 nm, 3 nm, 2 nm, or 1 nm, or L₁, L₂, and L₃ may be identical to each other.

The pores 15b may be, as illustrated in FIG. 3, three-dimensionally arranged in such a way that the imaginary triangle formed by connecting the centers A₁, A₂, and A₃ of three adjacent pores among the pores 15b is a regular, i.e., equilateral, triangle, or an approximation thereof.

The pores 15b may be, as illustrated in FIG. 3, three-dimensionally arranged in such a way that 0 nm≦L₁-D₁-D₂ (a distance between adjacent pores)≦100 nm (for example, 10 nm≦L₁-D₁-D₂≦100 nm) where L₁ is the length of a side of the imaginary triangle formed by connecting the centers A₁, A₂, and A₃ of three adjacent pores among the pores 15b, and D₁ and D₂ are diameters of pores that are included in the selected side.

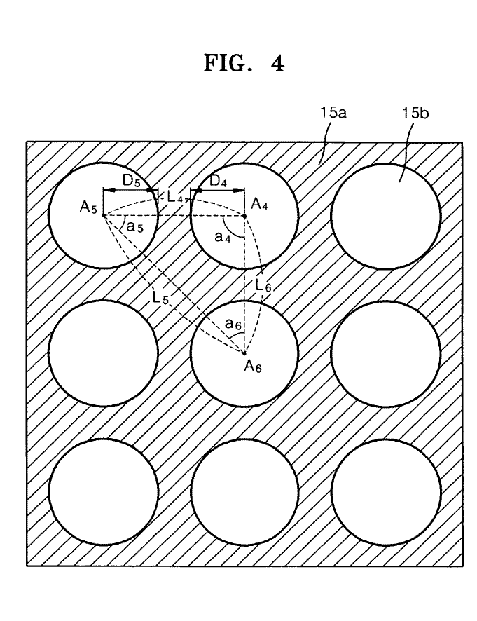

FIG. 4 illustrates an enlarged schematic view of a portion of the active material layer 15 of FIG. 2 according to another embodiment.

The pores 15b illustrated in FIG. 4 may all be spherical.

According to the present embodiment, the pores 15b in the active material layer 15 of the negative electrode 10 may be, as illustrated in FIG. 4, three-dimensionally arranged such that one of interior angles a₄, a₅ and a₆ of an imaginary triangle formed by connecting centers A₄, A₅ and A₆ of three adjacent pores among the pores 15b may be about 90±10°, for example, about 90±5°.

For example, the pores 15b may be arranged such that one of interior angles a4, a5, and a6 of the imaginary triangle may be about 90±5°, 90±4°, 90±3°, 90±2°, 90±1°, or 90°.

The pores 15b may be, as illustrated in FIG. 4, three-dimensionally arranged such that differences in lengths L₄, L₅, and L₆ of sides of the imaginary triangle formed by connecting the centers A₄, A₅ and A₆ of three adjacent pores among the pores 15b, i.e., the absolute value of L₄-L₅, the absolute value of L₅-L₆, and the absolute value of L₆-L₄, is less than about 10 nm.

For example, the pores 15b may be arranged such that the differences in the lengths L₄, L₅, and L₆ (the absolute value of L₄-L₅, the absolute value of L₅-L₆, and the absolute value of L₆-L₄) may each be about 10 nm, 9 nm, 8 nm, 7 nm, 6 nm, 5 nm, 4 nm, 3 nm, 2 nm, or 1 nm.

The pores 15b may be, as illustrated in FIG. 4, three-dimensionally arranged such that the imaginary triangle formed by connecting the centers A₄, A₅, and A₆ of three adjacent pores among the pores 15b is a right triangle or an approximation thereof.

The pores 15b may be, as illustrated in FIG. 4, three-dimensionally arranged such that 0 nm≦L₄-D₄-D₅≦100 nm (for example, 10 nm≦L₄-D₄-D₅≦100 nm) where L₄ is the length of one of the sides other than the longest side of the imaginary triangle formed by connecting the centers A₄, A₅, and A₆ of three adjacent pores among the pores 15b, and D₄ and D₅ are diameters of pores that are included in the selected side.

As described in the previous embodiments, when the pores 15b in the active material layer 15 are regularly distributed in the matrix 15a, a specific surface area of the active material layer 15 may be increased and a degree of freedom of intercalation and deintercalation of lithium ions may be higher than in an irregular matrix. Thus, the negative electrode 10 may have excellent capacity characteristics.

A residue coal may remain in one or more pore among the pores 15b. The pores 15b may be formed by, e.g., removing templates for forming pores by, e.g., heat-treating. For example, when polymer-based beads such as polystyrene-based beads, polycarbonate-based beads, polyacrylate-based beads, or polymethacrylate-based beads are used as templates, residue coal that is not removed as gas may remain in the pores 15b after the heat treatment of the template. Thus, the term “residue coal” in the present specification may be regarded as a material remaining after heat-treating of templates for forming pores, i.e., polystyrene residue, polycarbonate residue, polyacrylate residue, and/or polymethacrylate residue.

A porosity of the active material layer 15 may be about 20% to about 80%. In an implementation, the porosity may be about 30% to about 70%. The porosity of the active material layer 15 may be a percentage of a total volume of all the pores 15b in the active material layer 15 based on a total volume of the active material layer 15. Although not limited to the following theory, the porosity described above may be obtained since the pores 15b are regularly arranged, as illustrated in FIGS. 3 and 4. Thus, the active material layer 15 may contain more lithium ions and thus may have excellent capacity characteristics.

The specific surface area of the active material layer 15 may be about 100 m²/g to about 700 m²/g. In an implementation, the specific surface area may be about 500 m²/g to about 600 m²/g. The specific surface area may be referred to as an entire surface area of the active material layer 15 per gram. Although not limited to the following theory, the specific surface described above may be obtained since the pores 15b are regularly arranged, as illustrated in FIGS. 3 and 4. Thus, the active material layer 15 may contain more lithium ions and thus may have excellent capacity characteristics.

A thickness of the active material layer 15 may be about 1 μm to about 20 μm. In an implementation, the thickness may be about 3 μm to about 6 μm, but is not limited thereto.

A method of manufacturing the negative electrode 10 according to an embodiment may include forming a first layer on a collector. The first layer may include a plurality of templates for forming pores. Then, a second layer may be formed by providing a mixture containing a precursor of indium tin oxide to the first layer in order to introduce the mixture among the templates. Then, an active material layer may be formed on the collector by heat-treating the collector including second layer thereon to remove the templates and to convert the precursor of indium tin oxide into an indium tin oxide matrix. Accordingly, the active material layer may include the indium tin oxide matrix and a plurality of pores in the indium tin oxide matrix.

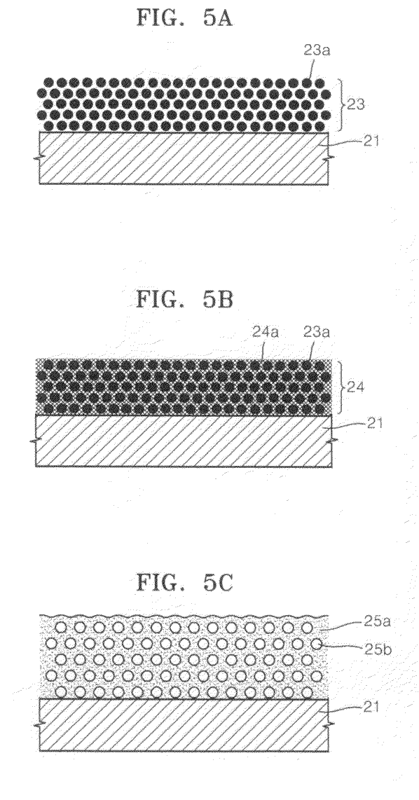

A minimum diameter of the templates may be about 200 nm and a maximum diameter of the template may be about 500 nm. A minimum diameter of the pores may be about 200 nm and a maximum diameter of the pores may be about 500 nm. Since the pores may be formed in areas from which the templates have been removed, the diameters of the pores may correlate to the diameters of the templates. Hereinafter, referring to FIGS. 5A through 5C, the method of manufacturing the negative electrode 10 according to the present embodiment will be described in detail.

First, as illustrated in FIG. 5A, a first layer 23 including templates 23a for forming pores may be formed on a collector 21. A minimum diameter of the templates 23a may be about 200 nm and a maximum diameter may be about 500 nm, but the minimum diameter and the maximum diameter are not limited thereto. The templates 23a may be, e.g., spherical. The templates 23a may be substantially removed by, e.g., a subsequent heat treatment, thereby replacing the templates 23a with pores. There may be no empty space between the templates 23a in FIG. 5A. However, there may be no adhesion between the templates 23a so that a material 24a containing a precursor of a material, enabling intercalation and deintercalation of lithium ions may be provided as illustrated in FIG. 5B.

The templates 23a may include any suitable material that is removable by heat-treatment. The templates 23a may be nano-sized as described above. For example, the templates 23a may be polymer-based beads such as polystyrene-based beads, polycarbonate-based beads, polyacrylate-based beads, polymethacrylate-based beads, and a combination thereof, but are not limited thereto.

The first layer 23 may be formed by providing a mixture including the templates 23a and a solvent to a top portion of the collector 21 and heat-treating the mixture to remove the solvent. The solvent may be, e.g., ethanol, but is not limited thereto.

The mixture including the templates 23a and the solvent may be provided to a top portion of the collector 21 by using various known methods, e.g., a spraying method, a spin coating method, an inkjet printing method, a dipping method, or a spin-coating method. However, other methods may also be used.

In the first layer 23, the templates 23a may be arranged having various regularities. For example, as illustrated in FIGS. 3 and 4, the templates 23a may be arranged having the same regularity as that of the pores 15b.

For example, all of the templates 23a of the first layer 23 may be spherical; and the templates 23a may be three-dimensionally arranged such that each of interior angles of an imaginary triangle formed by connecting centers of three adjacent templates among the templates 23a may be about 60±10°, i.e., the imaginary triangle may be an equilateral triangle. In another implementation, one of the interior angles may be about 90±10°, i.e., the imaginary triangle may be a right triangle.

Alternatively, all of the templates 23a of the first layer 23 may be spherical; and the templates 23a may be three-dimensionally arranged such that an absolute value of differences in lengths of each of two sides of an imaginary triangle formed by connecting centers of three adjacent templates among the templates 23a is less than about 10 nm.

Alternatively, all of the templates 23a of the first layer 23 may be spherical; and the templates 23a may be arranged such that the imaginary triangle formed by connecting centers of three adjacent templates among the templates 23a is an equilateral triangle or a right triangle.

Then, a mixture 24a containing a precursor of a material enabling intercalation and deintercalation of lithium ions may be provided to the first layer 23, thereby forming a second layer 24 including the mixture 24a filling spaces between the templates 23a, as illustrated in FIG. 5B.

The precursor of the material enabling intercalation and deintercalation of lithium ions included in the mixture 24a may vary according to a target material enabling intercalation and deintercalation of lithium ions, a target heat-treatment temperature, and a target bead. For example, if ITO is to be used as the material enabling intercalation and deintercalation of lithium ions, the precursor of the material enabling intercalation and deintercalation of lithium ions may include an indium oxide and a tin oxide or an ITO. However, the precursor of the material is not limited thereto.

The mixture 24a may further include, in addition to the precursor, a solvent. The solvent may be any suitable material that provides fluidity to the mixture 24a and is removable by heat-treatment. For example, the solvent may be ethanol, but is not limited thereto.

Then, the collector 21 including second layer 24 thereon may be heat-treated. Accordingly, the templates 23a may be removed; and the precursor of the material enabling intercalation and deintercalation of lithium ions may be converted into the material enabling intercalation and deintercalation of lithium ions. Thus, as illustrated in FIG. 5C, an active material layer having a matrix 25a structure including the material enabling intercalation and deintercalation of lithium ions and pores 25b distributed in the matrix 25a may be formed on the collector 21.

The heat-treatment may be performed under a condition, at a temperature, and for a time, such that the templates 23a are substantially removed and that the precursor of the material enabling intercalation and deintercalation of lithium ions is converted into the material enabling intercalation and deintercalation of lithium ions. For example, the heat-treatment may be performed under atmospheric conditions, at a temperature of about 300° C. to about 500° C., and for about 3 to about 4 hours. However, other conditions, other temperature ranges, and other time ranges may also be used.

As a result of the heat-treatment, the templates 23a may be removed and the pores 25a may replace the templates 23a. Thus, the shape and diameter of the pores 25a may be substantially identical to the shape and diameter of the templates 23a.

The negative electrode described above may be used in a lithium battery. For example, according to an embodiment, a lithium battery may include the negative electrode described above, a positive electrode, and an electrolyte.

The positive electrode may include a collector and a positive electrode active material layer on the collector. A positive electrode active material for forming a positive electrode active material layer may be a compound (lithiated intercalation compounds) reversibly enabling intercalation and deintercalation of lithium ions. The positive electrode active material may include at least one type of complex oxide including, e.g., complex oxides of lithium, and a metal including, e.g., cobalt, manganese, nickel, and a combination thereof. The positive electrode active material may be represented by any one of the following formulae:

LiₐA_{1-b}X_{b}D₂ where 0.95≦a≦1.1 and 0≦b≦0.5; LiₐE_{1-b}X_{b}O_{2-c}D_{c} where 0.95≦a≦1.1, 0≦b≦0.5, and 0≦c≦0.05; LiE_{2-b}X_{b}O_{4-c}D_{c} where 0≦b≦0.5, and 0≦c≦0.05; LiₐNi_{1-b-c}CobBcDα where 0.95≦a≦1.1, 0≦b≦0.5, 0≦c≦0.05, and 0≦α≦2; LiₐNi_{1-b-c}CobX_{c}O_{2-α}M_{α} where 0.95≦a≦1.1, 0≦b≦0.5, 0≦c≦0.05, and 0≦α≦2; LiₐNi_{1-b-c}CobX_{c}O_{2-α}M₂ where 0.95≦a≦1.1, 0≦b≦0.5, 0≦c≦0.05, and 0≦α≦2; LiₐNi_{1-b-c}Mn_{b}X_{c}D_{α} where 0.95≦a≦1.1, 0≦b≦0.5, 0≦c≦0.05, and 0≦α≦2; LiₐNi_{1-b-c}Mn_{b}X_{c}O_{2-α}M_{α} where 0.95≦a≦1.1, 0≦b≦0.5, 0≦c≦0.05, and 0≦α≦2; LiₐNi_{1-b-c}Mn_{b}X_{c}O_{2-α}M₂ where 0.95≦a≦1.1, 0≦b≦0.5, 0≦c≦0.05, and 0≦α≦2; LiₐNi_{b}E_{c}G_{d}O₂ where 0.90≦a≦1.1, 0≦b≦0.9, 0≦c≦0.5, and 0.001≦d≦0.1; LiₐNi_{b}CO_{c}Mn_{d}GₑO₂ where 0.90≦a≦1.1, 0≦b≦0.9, 0≦c≦0.5, 0≦d≦0.5, and 0.001≦e≦0.1; LiₐNiG_{b}O₂ where 0.90≦α≦1.1, and 0.001≦b≦0.1; LiₐCoG_{b}O₂ where 0.90≦a≦1.1, and 0.001≦b≦0.1; LiₐMnG_{b}O₂ where 0.90≦a≦1.1, and 0.001≦b≦0.1; LiₐMn₂G_{b}O₄ where 0.90≦a≦1.1, and 0.001≦b≦0.1; QO₂; QS₂; LiQS₂; V₂O₅; LiV₂O₅; LiZO₂; LiNiVO₄; Li_{3-f}J₂PO_{4 3} 0≦f≦2; Li_{3-f}Fe₂PO_{4 3} 0≦f≦2; and LiFePO₄.

In regard to these formulae, A may include, e.g., Ni, Co, Mn, and a combination thereof; X may include, e.g., Al, Ni, Co, Mn, Cr, Fe, Mg, Sr, V, a rare-earth element, and a combination thereof; D may include, e.g., O, F, S, P, and a combination thereof; E may include, e.g., Co, Mn, and a combination thereof; M may include, e.g., F, S, P, and a combination thereof; G may include, e.g., Al, Cr, Mn, Fe, Mg, La, Ce, Sr, V, and a combination thereof; Q may include, e.g., Ti, Mo, Mn, and a combination thereof; Z may include, e.g., Cr, V, Fe, Sc, Y, and a combination thereof; and J may include, e.g., V, Cr, Mn, Co, Ni, Cu, and a combination thereof. However, A, X, D, E, M, G, Q, Z, and J are not limited thereto.

The positive electrode active material may be coated with a coating layer. Alternatively, the positive electrode active material may be mixed with a material coated with a coating layer. The coating layer may include at least one coating element compound including, e.g., oxide of a coating element, hydroxide of a coating element, oxyhydroxide of a coating element, oxycarbonate of a coating element, and hydroxycarbonate of a coating element. The material for forming a coating layer may be amorphous or crystalline. The coating element contained in the coating layer may include, e.g., Mg, Al, Co, K, Na, Ca, Si, Ti, V, Sn, Ge, Ga, B, As, Zr, or a mixture thereof.

The coating layer may be formed using the coating element according to any suitable method that does not affect the properties of the positive electrode active material. For example, the coating layer may be formed by using a spray coating method or an immersion coating method, which are well known to those of ordinary skill in the art and thus will not be described in detail herein.

The positive electrode active material layer may include a binder and a conducting material.

The binder may help positive electrode active material particles adhere to each other, and may also help the positive electrode active material to adhere to the collector. The binder may include, e.g., polyvinyl alcohol, carboxymethylcellulose, hydroxypropylcellulose, diacetylcellulose, polyvinyl chloride, carboxylated polyvinylchloride, polyvinyl fluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and/or nylon.

The conducting material may provide conductivity to the positive electrode; and may be any suitable electron conducting material that does not cause any chemical change in a lithium battery. The conducting material may include, e.g., a carbonaceous material such as natural graphite, artificial graphite, carbon black, acetylene black, ketjen black, or carbon fiber; a metal such as copper, nickel, aluminum, or silver, each of which may be used in powder or fiber form; a conductive polymer such as a polyphenylene derivative; and a mixture thereof.

The collector may include, e.g., Al, but is not limited thereto.

The positive electrode may be manufactured by mixing the positive electrode active material, the conducting material, and the binder in a solvent to prepare an active material composition. Then, the active material composition may be coated on the collector. Such a method of manufacturing the positive electrode is well known in the art and thus will not be described in detail herein. The solvent may include, e.g., N-methylpyrrolidone, but is not limited thereto.

The electrolyte may include a non-aqueous organic solvent and a lithium salt.

The non-aqueous organic solvent may provide a medium through which ions engaging in an electrochemical reaction of the lithium battery may move.

The non-aqueous organic solvent may include, e.g., a carbonate-based solvent, an ester-based solvent, an ether-based solvent, a ketone-based solvent, an alcohol-based solvent, or a non-protonic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and ethylmethyl carbonate (EMC). Examples of the ester-based solvent may include methyl acetate, ethyl acetate, n-propyl acetate, dimethylacetate, methylpropionate, ethylpropionate, γ-butyrolactone, decanolide, valeolactone, mevalonolactone, and caprolactone. Examples of the ether-based solvent may include dibutylether, tetraglyme, diglyme, dimethoxyethane, 2-methyltetrahydrofurane, and tetrahydrofurane. Examples of the ketone-based solvent may include cyclohexanone. Examples of the alcohol-based solvent may include ethylalcohol and isopropyl alcohol. Examples of the non-protonic solvent may include a nitrile such as R—CN where R is a linear, branched, or cyclic C2 to C20 hydrocarbon group and may include a double bond aromatic ring or an ether bond; an amide such as dimethylformamide; and a dioxolane sulfolane such as 1,3-dioxolane.

These non-aqueous organic solvents may be used alone or in combination. If used in combination, a mixture ratio may be appropriately controlled according to a desired battery performance, which may be apparent to those of ordinary skill in the art.

The lithium salt may be dissolved in an organic solvent and may act as a supplier of lithium ions in the lithium battery and thus may enable basic operation of the lithium battery. In addition, the lithium salt may promote flow of lithium ions between the positive electrode and the negative electrode. The lithium salt may include, as a supporting electrolytic salt, one or two of, e.g., LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) where x and y are natural numbers, LiCl, LiI, and LiB(C₂O₄)₂(lithium bis(oxalato) borate; LiBOB). A concentration of the lithium salt may be about 0.1 M to about 2.0 M. Maintaining the concentration of the lithium salt at about 0.1 M to about 2.0 M may help ensure that the electrolyte has appropriate conductivity and viscosity and thus have excellent electrolyte performance and lithium ions may move efficiently.

According to the type of the lithium battery, a separator may be disposed between the positive electrode and the negative electrode. The separator may be a single or multi-layer separator including, e.g., polyethylene, polypropylene, or polyvinylidene fluoride. The separator may also be a mixed multi-layer separator, such as a double-layer separator containing polyethylene and polypropylene, a three-layer separator containing polyethylene, polypropylene, and polyethylene, or a three-layer separator containing polypropylene, polyethylene, and polypropylene.

Lithium batteries may be categorized as a lithium ion battery, a lithium ion polymer battery, or a lithium polymer battery, according to a separator used and an electrolyte used. Lithium batteries may also be categorized as a cylindrical lithium battery, a square-shaped lithium battery, a coin-shaped lithium battery, or a pouch-shaped lithium battery, according to the shape thereof. Lithium batteries may also be categorized as a bulk-type lithium battery or a thin layer-type lithium battery, according to the size thereof. The lithium batteries listed above may be primary batteries or secondary batteries. A method of manufacturing the lithium batteries is apparent to one skilled in the art and thus will not be described in detail herein.

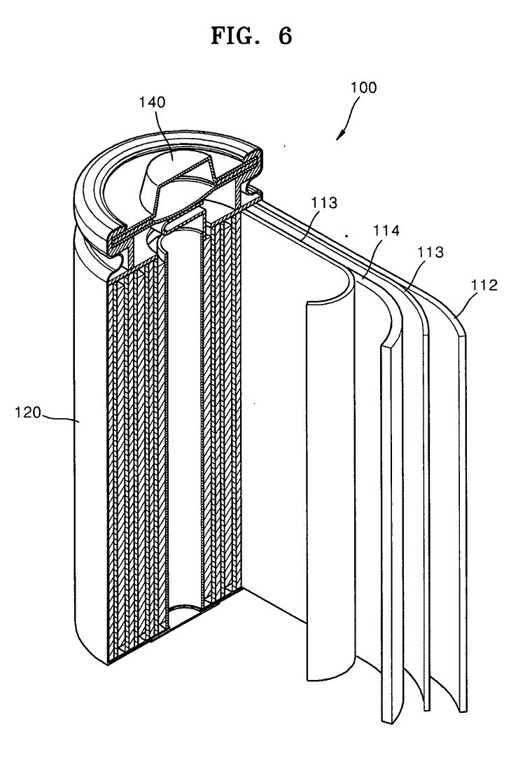

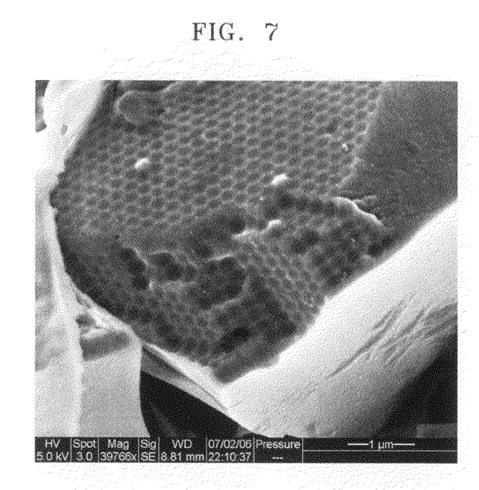

FIG. 6 illustrates an exploded perspective view of a lithium battery 100 according to an embodiment. Referring to FIG. 6, the lithium battery 100 may include a positive electrode 114, a negative electrode 112, a separator 113 interposed between the positive electrode 114 and the negative electrode 112, an electrolyte (not shown) with which the positive electrode 114, the negative electrode 112, and the separator 113 are impregnated, a battery container 120, and an encapsulation member 140 for sealing the battery container 120. The lithium secondary battery 100 illustrated in FIG. 3 may be assembled by sequentially stacking the positive electrode 114, the negative electrode 112, and the separator 113 and then winding the stack into a spiral in the battery container 120.

Hereinafter, Examples and Comparative Examples will be described. However, Examples below are only examples of the present invention and the present invention is not limited thereto.

### EXPERIMENTAL EXAMPLES

### Example 1

A 0.25 dm²-sized Cu foil was prepared and a surface oxide layer of the Cu foil was removed using a 20% H₂SO₄ aqueous solution. Then, the resultant Cu foil was washed with an alkali aqueous solution and deionized water, thereby preparing a Cu collector. Meanwhile, a mixture including: 200 g of polystyrene-based beads and 70 g of ethanol as a solvent was spin-coated to a thickness of 25 μm on the Cu collector. The polystyrene-based beads had an average particle diameter of 300 nm and had been prepared using a styrene monomer as a precursor, potassium persulfate as an initiator, and divinylbenzene as a crosslinker by emulsifier-free emulsion polymerization. Then, the Cu collector having the bead/solvent mixture thereon was heat-treated at a temperature of 120° C. for 3 hours, thereby forming a first layer including polystyrene-based beads on the Cu collector.

Then, a mixture including 30 g of an ITO as a precursor of ITO and 70 g of ethanol was dropped onto the first layer. The mixture permeated into spaces among polystyrene-based beads of the first layer, thereby forming a second layer.

Then, the Cu collector including the second layer was heat-treated under atmospheric conditions at a temperature of 450° C. for 4 hours, thereby removing the polystyrene-based beads and converting the precursor into an ITO layer. Thus, the manufacturing of an active material layer having an ITO matrix structure including pores was completed. Accordingly, a negative electrode including the active material layer and the Cu collector was completely manufactured.

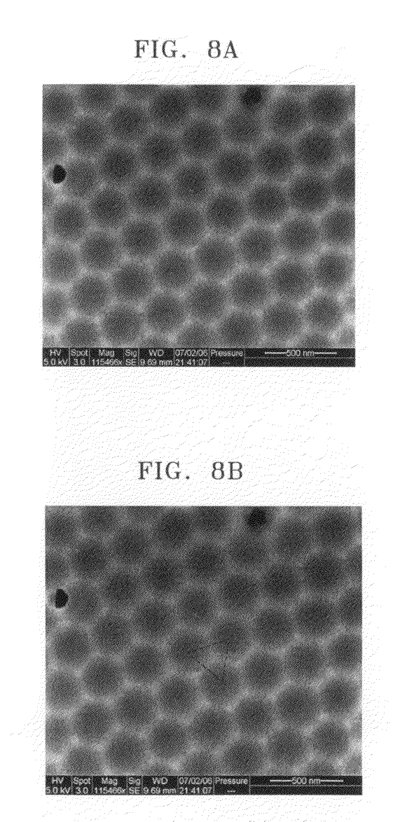

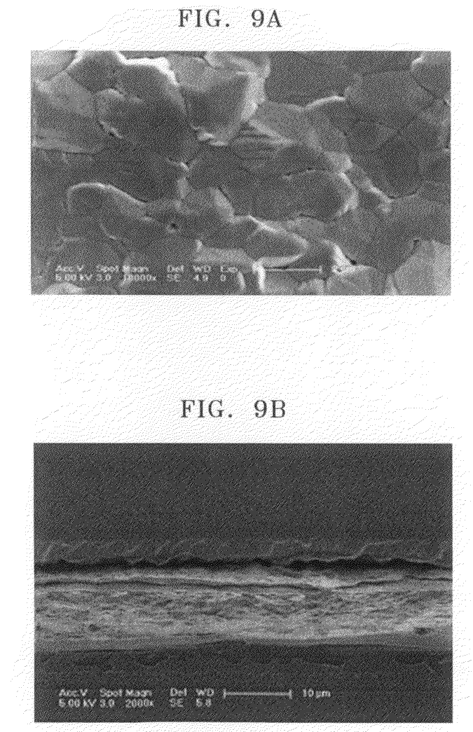

FIGS. 7 and 8A illustrate cross-sectional views of the prepared active material layer at different resolutions. Referring to FIG. 8A, it may be seen that pores were three-dimensionally present in the surface and inside of the active material layer. In FIG. 8A, black circles are cross-sections of the pores and gray parts are the ITO matrix. Referring to FIG. 8A, the pores were spherical and had a particle diameter of about 200 nm. Meanwhile, FIG. 8B illustrates an imaginary triangle formed by connecting centers of three adjacent pores among pores illustrated in FIG. 8A, and illustrates that the imaginary triangle is substantially an equilateral triangle. The length of each of sides of the imaginary triangle was about 300 nm, and a distance between pores, i.e., the length of a selected side minus diameters of pores contained on the selected side, was about 100 nm, which was calculated according to the description presented with reference to FIG. 3.

### Comparative Example 1

A Cu collector was prepared in the same manner as in Example 1 by removing a surface oxide layer of a 0.25 dm²-sized Cu foil. Then, a 0.2 M SnSO₄ and 0.003 M CuSO₄-containing electrolytic bath was prepared. A Sn electrode was used as a plating electrode and the Cu foil was used as a to-be-plated electrode. The temperature of the electrolyte was controlled to be about 50° C. Then, electro-plating was performed with a current of 12 A/dm² for 0.45 minute while stirring the electrolyte at a rate of 50 rpm. As a result, a Sn:Cu alloy active material layer having a thickness of 20 μm was formed on the Cu collector, thereby completely manufacturing of a negative electrode. The results are illustrated in FIGS. 9A and 9B, wherein the Sn:Cu alloy active material layer does not include pores. FIGS. 9A and 9B illustrate SEM images of the surface and cross-section of the Sn:Cu alloy active material layer, respectively.

Evaluation

1) Manufacturing of Batteries

Test cells were manufactured to perform an electrochemical characteristics test by using negative electrodes manufactured according to Comparative Example 1 and Example 1.

The negative electrodes manufactured according to Comparative Example 1 and Example 1 were used as a negative electrode and a lithium electrode were used as a positive electrode. The positive and negative electrodes were wound together with a separator including polyethylene and having a thickness of 20 μm and then pressed. Then, an electrolyte was injected thereto to completely manufacture a coin-cell battery. The electrolyte was prepared by dissolving LiPF₆ with a mixed solvent including ethylene carbonate, (EC), ethylmethyl carbonate (EMC) and diethyl carbonate (DEC) in a volume ratio of 3:5:2 such that the concentration of LiPF₆ was 1.15 M.

2) Charge and Discharge Characteristics Evaluation

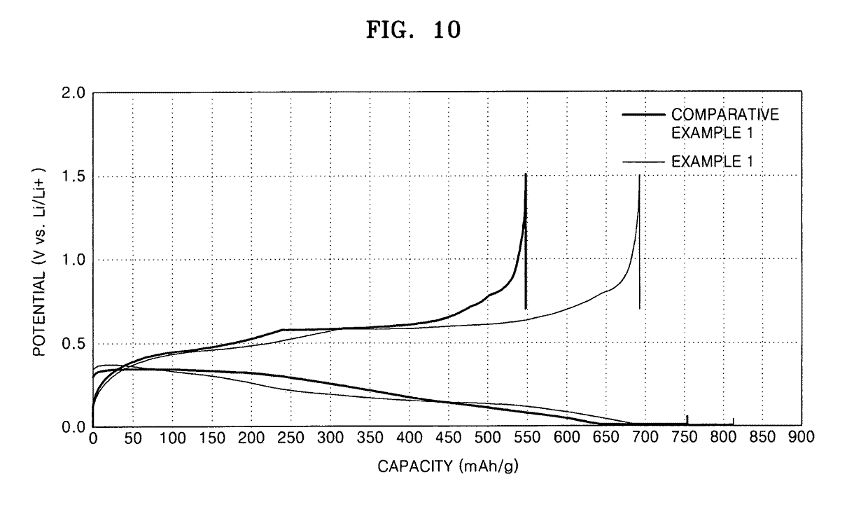

Charge and discharge characteristics of the test cells including the negative electrodes manufactured according to Comparative Example 1 and Example 1 were measured. The results are shown in Table 1 and FIG. 10:

TABLE 1

| | Discharging (mAh/g) | | |
|---|---|---|---|
| | (0.5 C) | Charging (mAh/g) | Efficiency |
| Comparative | 547.5983 | 753.1400 | 73% |
| Example 1 | | | |
| Example 1 | 692.6241 | 812.1859 | 85% |

Charging and discharging were performed under the following conditions.

Charging: CC-CV 0.2 C/0.01V [cut-off 0.01 C]

Discharging: CC 0.2 C [cut-off 1.5V]

Referring to FIG. 10, the test cell including the negative electrode manufactured according to Example 1 exhibited better charge and discharge efficiency characteristics than the test cell including the negative electrode manufactured according to Comparative Example 1.

As described above, a lithium battery including a negative electrode for a lithium battery according to an embodiment may have excellent capacity characteristics. Accordingly, the lithium battery including a negative electrode according to an embodiment may not exhibit a reduction in cycle lifetime associated with other non-carbonaceous materials when the lithium secondary battery swells and shrinks during charging and discharging.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A negative electrode for a lithium battery, the negative electrode comprising:
a collector; and
an active material layer, wherein the active material layer includes an indium tin oxide material capable of intercalation and deintercalation of lithium ions.

2. The negative electrode as claimed in claim 1, wherein the active material layer has a matrix structure including a plurality of pores.

3. The negative electrode as claimed in claim 2, wherein the pores have a minimum diameter of about 200 nm and a maximum diameter of about 500 nm.

4. The negative electrode as claimed in claim 2, wherein one or more pores among the pores are spherical.

5. The negative electrode as claimed in claim 2, wherein a standard deviation of diameters of the pores is about 0 nm to about 10 nm.

6. The negative electrode as claimed in claim 2, wherein:
all of the pores are spherical, and
the pores are three-dimensionally arranged such that:
each of interior angles of an imaginary triangle formed by connecting centers of three adjacent pores among the pores is about 60±10°, or
one of the interior angles is about 90±10°.

7. The negative electrode as claimed in claim 2, wherein:
all of the pores are spherical, and
the pores are three-dimensionally arranged such that absolute values of differences in lengths of sides of an imaginary triangle formed by connecting centers of three adjacent pores among the pores are less than about 10 nm.

8. The negative electrode as claimed in claim 2, wherein:
all of the pores are spherical, and
the pores are three-dimensionally arranged such that an imaginary triangle formed by connecting centers of three adjacent pores among the pores is an equilateral triangle or a right triangle.

9. The negative electrode as claimed in claim 2, wherein:
all of the pores are spherical, and
the pores are three-dimensionally arranged such that 0 nm≦L₁-D₁-D₂≦100 nm where L₁ is a length of a side of an imaginary triangle formed by connecting centers of three adjacent pores among the pores and D₁ and D₂ are diameters of pores that are contained in the selected side.

10. The negative electrode as claimed in claim 2, wherein:
all of the pores are spherical, and
the pores are three-dimensionally arranged such that 0 nm≦L₄-D₄-D₅≦100 nm where L₄ is a length of one of the sides other than a longest side of an imaginary triangle formed by connecting centers of three adjacent pores among the pores, and D₄ and D₅ are diameters of pores that are contained in the selected side.

11. The negative electrode as claimed in claim 2, wherein one or more pores among the pores includes a residue coal.

12. The negative electrode as claimed in claim 2, wherein the active material layer has a porosity of about 20% to about 80%.

13. The negative electrode as claimed in claim 1, wherein the active material layer has a specific surface area of about 100 m²/g to about 700 m²/g.

14. A lithium battery, comprising:
the negative electrode as claimed in claim 1,
a positive electrode, and
an electrolyte.

15. A method of manufacturing a negative electrode for a lithium battery, the method comprising:
forming a first layer on a collector such that the first layer includes a plurality of templates for forming pores;
forming a second layer by providing a mixture including a precursor of indium tin oxide to the first layer to introduce the mixture among the templates; and
forming an active material layer on the collector by heat-treating the collector having the first layer and the second layer thereon to remove the templates and to convert the precursor of the indium tin oxide into an indium tin oxide matrix, such that the active material layer having an indium tin oxide matrix structure includes a plurality of pores.

16. The method as claimed in claim 15, wherein the templates have a minimum diameter of about 200 nm and a maximum diameter of about 500 nm.

17. The method as claimed in claim 15, wherein the templates include at least one of polystyrene-based beads, polycarbonate-based beads, polyacrylate-based beads, and polymethacrylate-based beads.

18. The method as claimed in claim 15, wherein:
all of the templates are spherical; and
the templates are arranged such that an imaginary triangle formed by connecting centers of three adjacent templates among the templates is an equilateral triangle or a right triangle.

19. The method as claimed in claim 15, wherein the heat-treatment is performed at a temperature of about 300° C. to about 400° C.

20. The method as claimed in claim 15, wherein the pores replace the templates as the templates are removed.
